(19) United States
(12) Patent Application Publication
(10) Pub. No.: US 2017/0070186 A1
(43) Pub. Date: Mar. 9, 2017

(54) Light-converting device

(71) Applicants: Nuhim Heifets, West Hollywood, CA (US); Eugene Heifets, West Hollywood, CA (US)

(72) Inventors: Nuhim Heifets, West Hollywood, CA (US); Eugene Heifets, West Hollywood, CA (US)

(21) Appl. No.: 14/756,487

(22) Filed: Sep. 9, 2015

(51) Int. Cl. H02S 20/30; F24J 2/00

(52) U.S. Cl. CPC H02S 20/30; F24J 2/0007

(57) ABSTRACT

In the light-converting device the light-converting elements (11) are arranged at least on two levels. They are placed on the strips (17). The design is supported at least by one pole (23). Because of it in this device light-converting elements may be arranged on many levels and consequently much less place for it is required and new possibilities appear. The device may be installed for instance on a roof of buildings in the best direction at any side of inclined roof. The device may also be installed on slopes of mountains, in rivers, lakes, coastal zones of seas and oceans, on vehicles, and trailers. The device may be installed on ships standing immovably not very far from the coast and connected to the coast by a cable. The device may be used on military bases, and on the moon. The device is used on military bases will decrease dependence on the fuel supply.

### CROSS-REFERENCE TO RELATED APPLICATIONS

This application claims the benefits of provisional patent applications Ser. No. 62/070,986, filed 2014 Sep. 10 and Ser. No. 62/125,395, filed 2015 Jan. 20 by the present inventors.

### BACKGROUND—PRIOR ART

The following is a tabulation of some prior art that presently appears relevant:

U.S. Patents (Class 136)

| Pat. No. | Kind Code | Issue Date | Patentee |
|---|---|---|---|
| None | | | |

U.S. Patent Application Publications

| Publication Nr. | Kind Code | Publ. Date | Applicant |
|---|---|---|---|
| None | | | |

Foreign Patent Documents

| Foreign Doc. Nr. | Cntry Code | Kind Code | Pub. Dt | App or Patentee |
|---|---|---|---|---|
| None | | | | |

### NONPATENT LITERATURE DOCUMENTS

Falk Antony, Christian Durschner, Karl-Heinz Remmers book, Photovoltaics for Professionals (2007)

This relates to the field utilizing of solar energy.

Given “Light-converting device” comprises four different devices for:
converting sunlight to electrical energy;
converting sunlight to heat energy for heating water;
converting sunlight to heat energy for heating air; and
changing of sun rays direction.

Said devices are called “light-converting elements” in this specification and claims.

At present light-converting elements are placed horizontally or inclined on big areas of earth surface. Sometimes they are placed inclined on a roof of buildings.

Installing light-converting elements for converting sunlight to electrical energy is shown in different books. For instance it is shown in book “Photovoltaics for Professionals” by Falk Antony, Christian Durschner, Karl-Heinz Remmers (2007) pages 100, 103, and 128.

Therefore for utilizing sun energy at present big areas of the earth and located somewhere big plots are required.

### SUMMARY

The present device consists of four or five principal parts:

the light-converting elements arranged at least on two levels;

strips on which the light-converting elements are placed;

at least one pole on which the strips are placed and fixed; and

means for fixing the pole.

### Or

the light-converting elements arranged at least on two levels;

strips on which the light-converting elements are placed;

at least one inclined beam on which the strips are placed and fixed;

at least one pole on which the whole design is placed and fixed; and

means for fixing the pole.

For the new device much less place is required. Owing to the fact many new possibilities appear.

### Advantages

For the present device much less place is required.

The device may be installed on a roof of buildings in the best direction at any side of the inclined roof.

The device may be installed also on street lighting posts, power transmission masts, high palm trunks, slopes of mountains, along electrical rail roads, in rivers, lakes, coastal zones of seas and oceans, on vehicles, and trailers. The device with the single pole may be installed on a turning device. The device may be installed on ships standing immovably not very far from coast and connected to coast by a cable. The device may be used on military bases and on the moon.

Vehicles, trailers and ships are called “devices able to move” in this specification and claims.

Other advantages will be apparent from a consideration of the drawings and ensuing description.

### DRAWINGS—FIGURES

At all accompanying drawings the light-converting device is showed for the case of converting sunlight to electrical energy. Devices for converting sunlight to heat energy for heating water and air and for changing of sun rays direction can be made by analogy.

FIGS. 1 and 2 show the principal embodiment of the device. FIG. 1 is a front view, and FIG. 2 is a right-side view of FIG. 1. All the strips have the same width. The design is supported by one pole and located on the ground.

FIG. 3 shows a right-side view of FIG. 1 too but for another embodiment wherein the upper strip protrudes rear of the strips placed lower of it and the lower one protrudes forward of the strips placed over of it. The strips placed between the upper and lower ones have the same width.

FIG. 4 shows a front view of a big embodiment which has a large length and is supported by more than one pole.

FIG. 5 shows a right-side view of another embodiment of FIG. 1 wherein the light-converting elements are placed so that beginning with the second level the front edge of each of them is located between the front and rear edges of the light-converting elements located under them. This embodiment has a straight vertical pole.

FIG. 6 shows a right-side view of another embodiment wherein the light-converting elements are placed so that beginning with the second level the front edge of each of them is located between the front and rear edges of the light-converting elements located under them. This embodiment has a pole consisting of two parts: a lower one is straight vertical and upper is inclined.

FIG. 7 shows a right-side view of another embodiment wherein the light-converting elements are placed inclined and have different inclination. The light-converting elements are placed on the strips. The strips are placed and fixed on at least one inclined beam. The whole design is supported and fixed by at least one pole. The pole is placed and fixed in the foundation.

Drawings-Reference Numerals

| | | | |
|---|---|---|---|
| 11 | light-converting elements | 13 | front side |
| 15 | rear side | 17 | strips |
| 19 | front edge of strips | 21 | rear edge of strips |
| 23 | pole | 25 | foundation |
| 27 | second level | 29 | front edge of light-converting |
| | | | elements |
| 31 | rear edge of light-converting | 33 | lower part of pole |
| | elements | | |
| 35 | upper part of pole | 37 | inclined beam |

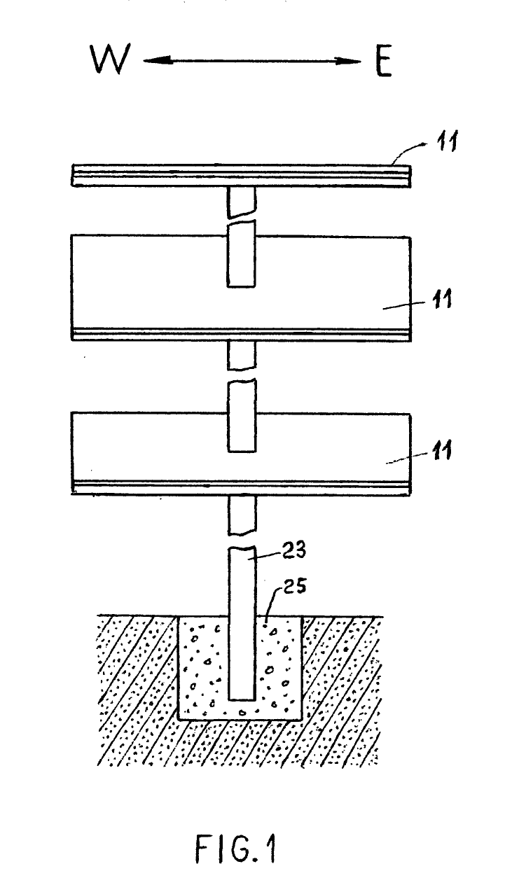

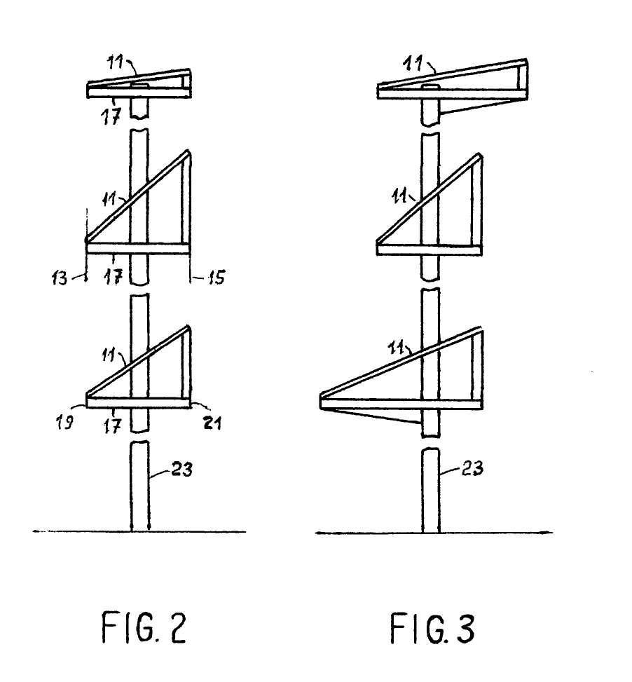

### DETAILED DESCRIPTION—FIGS. 1 and 2—FIRST EMBODIMENT

The principal embodiment of the light-converting device which is located on the ground is showed in FIGS. 1 and 2. The device comprises the light-converting elements 11 arranged one above the other at least on two levels. The device has a front side 13 and a rear one 15. The light-converting elements are placed inclined and have different inclination. The device has strips 17 on which the light-converting elements are placed. The strips have a front edge 19 and a rear one 21 and are arranged horizontally. The strips may also be arranged inclined and have either the same inclination or different ones. In this case the rear edge will be arranged higher than the front one. For supporting and fixing the strips there is a pole 23. The pole is installed and fixed on a foundation 25.

The means for supporting and fixing strips may be different. One of the simplest is showed in FIG. 1 and FIG. 2.

The light-converting device may be installed differently with respect to the cardinal points. But the most advantageous installation is when the front edges of the light-converting elements are parallel to the West-East direction and the front side of the device is directed to the equator. This device may be installed on land, building roofs, slopes of mountains, along electrical rail roads, in rivers, lakes, coastal zones of seas and oceans, on vehicles, trailers and ships. When the device is installed on a ship a floating breakwater should be installed in front of it. And the device may be installed on street lighting posts, power transmission masts, and high palm trunks. The device may be used on military bases and on the moon.

The device with the single pole may be installed on a turning device which is installed and fixed on the foundation. In this case the light-converting device acquires the possibility to turn after the sun moving. Such the turning device has been widely known and used very long in the tower and truck cranes. The attachment of the light-converting device to the turning device may be done in the same way as a mast of the tower cranes is attached to its turning device.

The reference numerals on all figures are the same as on FIGS. 1 and 2 for the same elements.

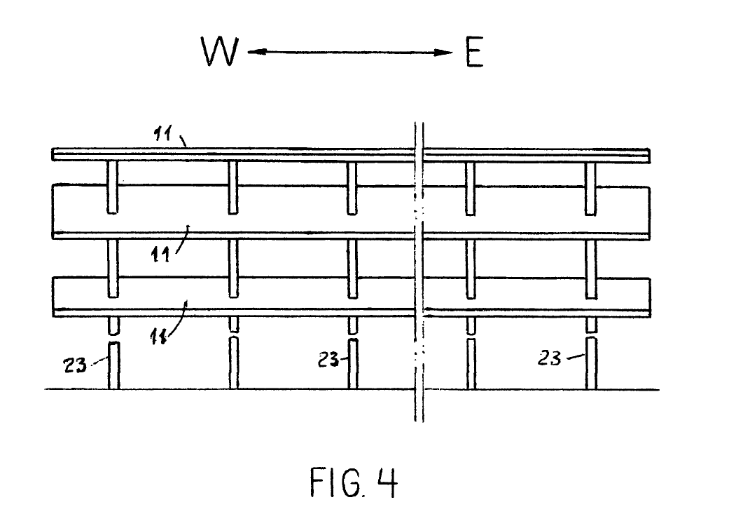

Another embodiment of the invention is showed in FIG. 3. In this embodiment the lower of the strips protrudes forward of the strips placed over of it and the upper of the strips protrudes rear of the strips placed the lower of it. The device may have either the upper strip protruding rear only or the lower strip protruding forward only. When the device has the lower strip protruding forward the strip may have a big size in this direction. In such a case this part will be not a strip but a big element. Under this element for instance a parking or a road may be arranged.

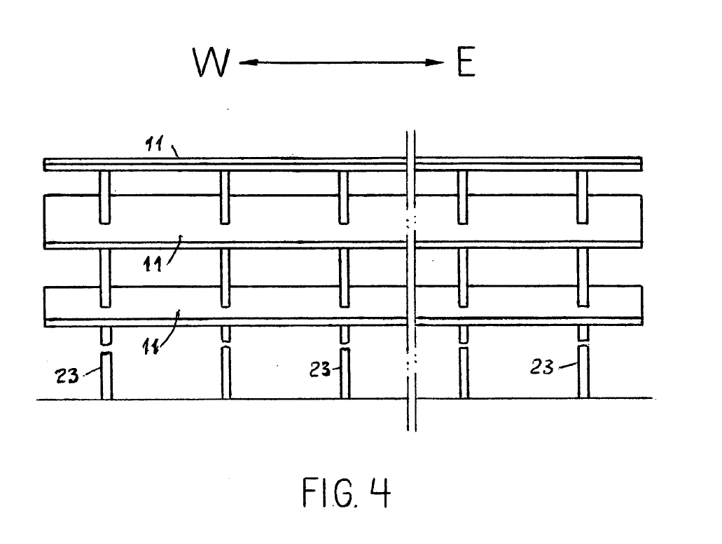

A front view of a big embodiment which has a large length and is supported by more than one pole is showed in FIG. 4. This embodiment allows getting a high quantity of energy.

The device may be installed on vehicles, trailers, and ships. The devices installed on vehicles and trailers must be located so that the front side of the embodiment will be arranged perpendicularly to the axis of the vehicle or trailer wheels. The devices installed on ships must be located so that the front side of the embodiment will be parallel to the ship keel. These devices must stand immovably. The ships are connected to a coast by a cable. The light-converting devices installed on vehicles and ships have the possibility to turn after the sun moving.

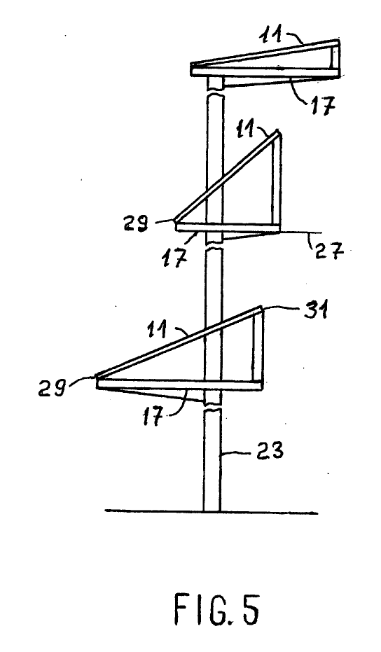

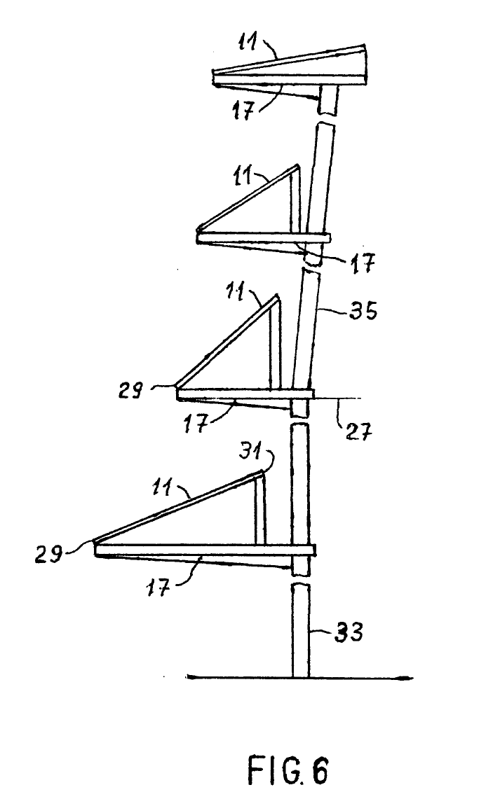

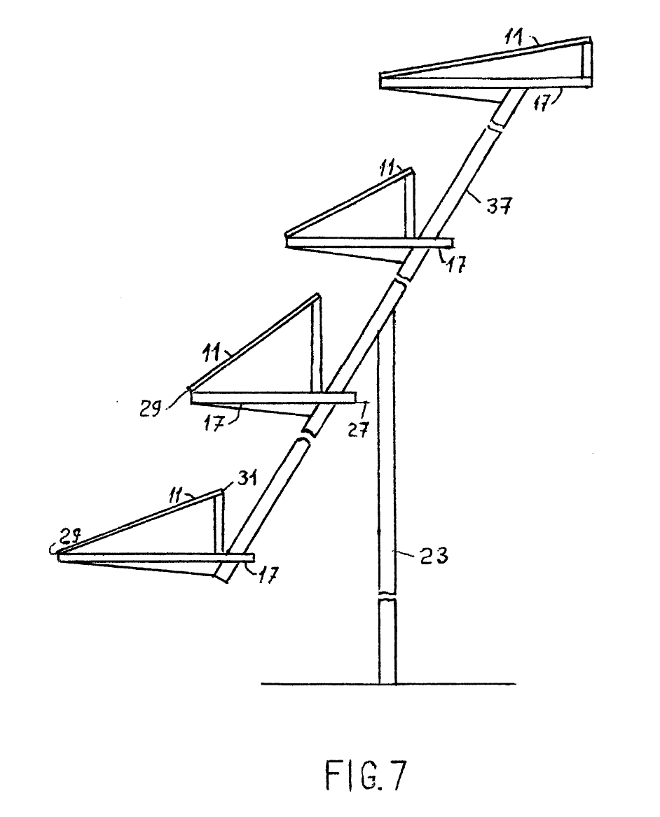

In embodiments showed in FIGS. 5, 6, and 7 the light-converting elements are placed so that beginning with the second level 27 the front edge 29 of the light-converting elements are located between the front 29 and the rear 31 edges of the light-converting elements are located under them. The embodiment showed in FIG. 5 has the straight vertical pole 23 and is intended for small devices having a few levels only. The embodiment showed in FIG. 6 has the pole consisting of two parts: the lower one 33 is straight vertical and the upper 35 is inclined. This embodiment is intended for high devices having many levels. In the embodiment showed in FIG. 7 the light-converting elements 11 are placed on the strips 17. And the strips are placed and fixed on at least one inclined beam 37. The whole design is supported and fixed by at least one pole 23. The pole is placed and fixed in the foundation. This embodiment is intended for the big devices.

### Operation

Under the sunlight action the device may: either produce current, or heat water, or heat air, or change the direction of sun rays.

The angle of the light-converting elements inclination renders a significant influence on the part of the day-time when the light-converting elements for producing electrical and heat energy give the most output. Therefore a definite combination of the light-converting elements with different inclinations permits to get energy from the sun in accordance with the demand for it.

Embodiments installed on turning devices, vehicles, trailers, and ships may turn after the sun moving under the control of an operator or a computer.

### Advantages

From the description above a number of advantages of the showed embodiments of my “Light-converting device” become evident:

(a) The light-converting elements arranged at least on two levels permit to place a great quantity of them on a small plot. Therefore the device allows getting much energy with the small plot.

(b) The device may be placed on a roof of buildings in the best direction at any side of the inclined roof.

(c) The device may be placed on street lighting posts, power transmission masts, high palm trunks, slopes of mountains.

(d) The device may be placed along electrical rail roads.

(e) The device may be placed in rivers, lakes, coastal zones of seas and oceans.

(f) The device with a single pole may be placed on the turning device.

(g) The device may be placed on “devices able to move”—on vehicles, trailers, and ships.

(h) The device may be used on military bases, and on the moon.

### Conclusion, Ramifications, and Scope

Accordingly, the reader will see that the light-converting device of the various embodiments creates many new possibilities for receiving energy from the sun with the maximum output. First of all the place for the device is required much less. Secondly the device being installed even on the inclined roof of buildings will be arranged in the best position. The device for instance having the light-converting elements arranged one over the other on 20 levels will produce energy 20 times more than known devices wherein the light-converting elements are arranged on one level. The device may be placed on street lighting posts, power transmission masts, high palm trunks, slopes of mountains. The device may be placed along electrical rail roads. The device may be placed in rivers, lakes, coastal zones of seas and oceans. The device with the single pole installed on the turning device may turn after the sun moving. The device may be installed on vehicles, trailers, and ships. The devices may be used on military bases, and on the moon. The device used on the military bases will decrease dependence on supplying of the fuel. The same may refer to different countries.

Although the description above contains much specificity, these should not be construed as limiting the scope of the embodiments but as merely providing illustration of some of several embodiments.

Thus the scope of the embodiments should be determined by the appended claims and their legal equivalents, rather than by examples given.

1. A light-converting device, comprising:
strips arranged horizontally one above the other at least on two levels, and having a front and a rear sides;
light-converting elements placed inclined on said strips; and
at least one pole on which said strips are placed and fixed.

2. The device of claim 1,wherein said light-converting elements have different inclinations.

3. The device of claim 1, wherein under of said strips protrudes forward of said strip placed over it.

4. The device of claim 1, wherein upper of said strips protrudes back of said strip placed below it.

5. The device of claim 4, wherein under of said strips protrudes forward of said strip placed over it.

6. A light-converting device, comprising:
strips arranged horizontally one higher the other at least on two levels, and having a front and a rear edges, and are placed so that beginning with the second level said front edge of said strip are located between said front and said rear edges of said strip located on a level below;
light-converting elements placed inclined on said strips; and
at least one pole on which said strips are placed and fixed.

7. The device of claim 6, wherein said light-converting elements have different inclinations.

8. A light-converting device, comprising:
strips arranged horizontally one higher the other at least on two levels, and having a front and a rear edges, and are placed so that beginning with the second level said front edge of said strip are located between said front and said rear edges of said strip located on a level below;
light-converting elements placed inclined on said strips;
at least one inclined beam on which said strips are placed and fixed; and
at least one pole supporting said device.

9. The device of claim 8, wherein-said light-converting elements have different inclinations.

10. A light-converting device, comprising:
strips arranged horizontally one higher the other at least on two levels, and having a front and a rear sides;
light-converting elements placed inclined on said strips;
at least one pole on which said strips are placed and fixed; and
a device able to move on which said pole is placed and fixed.

11. The device of claim 10, wherein said light-converting elements have different inclinations.

12. A light-converting device, comprising:
strips arranged horizontally one above the other at least on two levels, and having a front and a rear sides;
light-converting elements placed inclined on said strips;
a pole on which said strips are placed and fixed; and
a turning device on which said pole is placed and fixed.

13. The device of claim 12, wherein said light-converting elements have different inclinations.
